(19) United States
(12) Patent Application Publication
(10) Pub. No.: US 2024/0333781 A1
(43) Pub. Date: Oct. 3, 2024

(54) PROCESSING METHOD, SYSTEM, AND FIRST ELECTRONIC DEVICE

(71) Applicant: Lenovo (Beijing) Limited, Beijing (CN)

(72) Inventors: Mingping ZHANG, Beijing (CN); Yiguo ZHU, Beijing (CN)

(21) Appl. No.: 18/606,755

(22) Filed: Mar. 15, 2024

(30) Foreign Application Priority Data
Mar. 27, 2023 (CN) 202310305665.2

(51) Int. Cl. H04L 65/403; G06F 3/14

(52) U.S. Cl. CPC H04L 65/403; G06F 3/1454

(57) ABSTRACT

A connection mechanism includes a first connection unit, a second connection unit, and a separation and locking control structure. The second connection unit is separated from and locked with the first connection unit in an insertion method. The separation and locking control structure includes a first control member and a second control member. The first control member is connected to the first connection unit to drive the first connection unit to move between a first position and a second position. The second control member abuts against the second connection unit when the second connection unit is inserted into the first connection unit. The first control member and the second control member have a first status and a second status.

### CROSS-REFERENCE TO RELATED APPLICATION

The present disclosure claims priority to Chinese Patent Application No. 202310305665.2, filed on Mar. 27, 2023, the entire content of which is incorporated herein by reference.

### TECHNICAL FIELD

The present disclosure relates to the information processing technology field and, more particularly, to a processing method, a system, and a first electronic device.

### BACKGROUND

With the development of electronic devices, more and more electronic devices can be controlled collaboratively. For example, applications on a cell phone can be controlled and operated through a computer.

However, the current cross-device control operation process is cumbersome, which impairs user experience.

### SUMMARY

An aspect of the present disclosure provides a connection mechanism, including a first connection unit, a second connection unit, and a separation and locking control structure. The second connection unit is separated from and locked with the first connection unit in an insertion method. The separation and locking control structure includes a first control member and a second control member. The first control member is connected to the first connection unit to drive the first connection unit to move between a first position and a second position. The second control member abuts against the second connection unit when the second connection unit is inserted into the first connection unit. The first control member and the second control member have a first status and a second status. In the first status, the first connection unit is kept at the first position to allow the second connection unit to be inserted relative to the first connection unit to be locked. In the second status, the first connection unit is kept at the second position to allow the second connection unit to be pulled out relative to the first connection unit to be in a separated status.

An aspect of the present disclosure provides an electronic device, including a first body, a second body, and a connection mechanism. The connection mechanism connects the first body and the second body to achieve a detachable connection between the first body and the second body. The connection mechanism includes a first connection unit, a second connection unit, and a separation and locking control structure. The second connection unit is separated from and locked with the first connection unit in an insertion method. The separation and locking control structure includes a first control member and a second control member. The first control member is connected to the first connection unit to drive the first connection unit to move between a first position and a second position. The second control member abuts against the second connection unit when the second connection unit is inserted into the first connection unit. The first control member and the second control member have a first status and a second status. In the first status, the first connection unit is kept at the first position to allow the second connection unit to be inserted relative to the first connection unit to be locked. In the second status, the first connection unit is kept at the second position to allow the second connection unit to be pulled out relative to the first connection unit to be in a separated status.

### BRIEF DESCRIPTION OF THE DRAWINGS

FIG. 1 illustrates a schematic flowchart of a processing method according to some embodiments of the present disclosure.

FIG. 2 illustrates a schematic diagram of an application scenario according to some embodiments of the present disclosure.

FIG. 3 illustrates a schematic flowchart of adding an application identification of a cell phone to a PC terminal according to some embodiments of the present disclosure.

FIG. 4 illustrates a schematic diagram of embedding an application list of a cell phone in a corresponding identification display area of a personal computer (PC) according to some embodiments of the present disclosure.

FIG. 5 illustrates a schematic flowchart of activating a cell phone application from a PC according to some embodiments of the present disclosure.

FIG. 6 illustrates a schematic structural diagram of a processing system according to some embodiments of the present disclosure.

### DETAILED DESCRIPTION OF THE EMBODIMENTS

The technical solution of embodiments of the present disclosure is described in detail in connection with the accompanying drawings of embodiments of the present disclosure. Described embodiments are merely some embodiments of the present disclosure, not all embodiments. Based on embodiments of the present disclosure, all other embodiments obtained by those skilled in the art without creative efforts are within the scope of the present disclosure. To describe the technical solution of embodiments of the present disclosure in detail, in embodiments of the present disclosure, the terms “first,” “second,” etc., are used to distinguish the same or similar items with the same function and effect. For example, the first electronic device and the second electronic device are merely used to distinguish between different devices, without implying any sequence. Those skilled in the art can understand that the terms “first,” “second,” etc., do not limit the quantity or execution order, and do not necessarily imply difference.

With the development of technology, data transmission between different electronic devices can be achieved through network connections. For example, users can project video sources in the cell phone to the computer for playback based on a screen projection technology, which requires pairing the cell phone with the computer for connection (e.g., connected in a same wireless LAN). Then, the user can select the video to be projected on the cell phone, open the video application, and call the screen projection function. The operation process is cumbersome. Thus, embodiments of the present disclosure provide a processing method to simplify the operation steps across devices to enhance user experience.

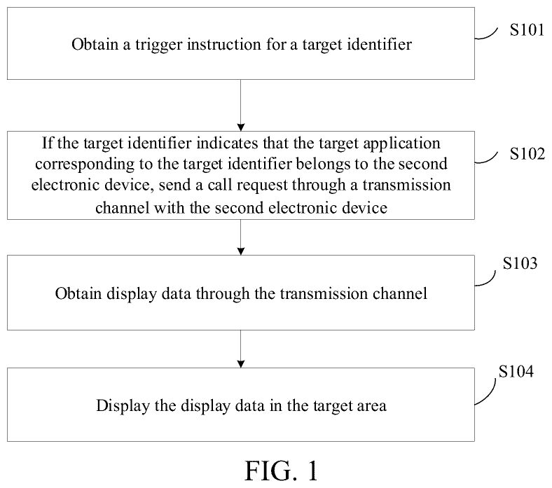

FIG. 1 illustrates a schematic flowchart of a processing method according to some embodiments of the present disclosure. The method includes the following processes.

At S101, a trigger instruction for a target identifier is obtained.

At S102, if the target identifier indicates that the target application corresponding to the target identifier belongs to the second electronic device, a call request is sent through a transmission channel with the second electronic device.

The identifier can be an icon, thumbnail, or graphic code representing the corresponding application. Multiple icons can be represented in a display area of a corresponding service of the first electronic device. In some embodiments, the icons can represent local applications of the first electronic device or applications of other electronic devices associated with the first electronic device. The other electronic devices associated with the first electronic device can be electronic devices communicatively connected to the first electronic device. The icons can also be the icons of the applications in a sub-device controlled by the first electronic device. An application corresponding to an identifier can be called by triggering the identifier of the identifiers. For example, a drawing identifier can correspond to an application with a drawing function. In some embodiments, when the first electronic device displays identifiers of applications of other electronic devices associated with the first electronic device, all identifiers of the other electronic devices can be displayed, or only identifiers of the electronic device that is currently communicatively connected to the first electronic device can be displayed. In some other embodiments, only identifiers of the applications of the other electronic devices stored in the operation history record can be displayed.

The target identifier is one of the above identifiers. An application corresponding to the target identifier can be a target application. When the target identifier is triggered with a specific operation, the trigger operation can be responded to through the application corresponding to the target identifier. For example, after the identifier for drawing is clicked, the main interface of the drawing application can be entered. In some embodiments, the target identifier can belong to the first electronic device, while the target application can belong to the second electronic device. In some embodiments, only the target identifier can be stored in the first electronic device locally, while the target application corresponding to the target identifier may not be stored in the first electronic device and can belong to the second electronic device. That is, the target application can be running on the second electronic device to complete the corresponding data processing.

In some embodiments, the types of the first electronic device and the second electronic device are not limited. For example, the first electronic device and the second electronic device can be electronic devices that support screen projection applications. In some embodiments, the first electronic device can be a laptop computer, desktop computer, tablet, or smart display device, and the second electronic device can be a phone or virtual display device. A transmission channel can be established between the first electronic device and the second electronic device. The transmission channel can be established based on a specific networking mode. For example, the transmission channel can be a WiFi (Wireless Fidelity) connection channel, i.e., a wireless transmission channel in a local area network (LAN).

The input apparatus of the first electronic device can be configured to receive a trigger operation for the target identifier. For example, if the input apparatus is a touch screen of the first electronic device, the trigger operation can be a touch operation for the target identifier displayed on the touch screen. In some other embodiments, if the input apparatus is a mouse of the first electronic device, the trigger operation can be a click operation for the target identifier. After the first electronic device receives the trigger operation, the processor of the first electronic device can be configured to convert the trigger operation into a trigger instruction to call the target application corresponding to the target identifier. Then, the processor of the first electronic device can send a call instruction to call the target application corresponding to the target identifier through the transmission channel with the second electronic device. To ensure that the first electronic device can successfully send a call request to the second electronic device through the transmission channel, the transmission channel needs to operate normally. That is, the transmission channel between the first electronic device and the second electronic device may need to exist. If the transmission channel is a wireless network transmission channel within the LAN, the second electronic device may need to be within a predetermined range of the first electronic device to ensure that the first electronic device and the second electronic device can access the same wireless network in the LAN. Furthermore, if the call request cannot be correctly sent, in practical application scenarios, when no execution response is received by triggering the target identifier, whether the transmission channel exists between the first electronic device and the second electronic device can be detected. If the transmission channel does not exist, the call request can be sent after the transmission channel is established. Correspondingly, a plurality of second electronic devices can be provided. Before sending the call request, to which second electronic device the target application corresponding to the target identifier belongs can be first determined. Then, the call request can be sent based on the corresponding transmission channel with the second electronic device.

At S103, display data is obtained through the transmission channel.

At S104, the display data is displayed in the target area.

The display data can be screen-recording data of the electronic device for the running target application. The screen-recording data can be a to-be-displayed data stream generated by the target application in real-time and displayed in the user interface when the target application is running after the second electronic device activates the target application. The second electronic device can include a physical display. Correspondingly, if the first electronic device and the second electronic device display the display data simultaneously, the screen-recording data can be the display data on the physical display of the second electronic device recorded by the second electronic device for the running target application.

Correspondingly, the physical display of the second electronic device may not display the to-be-displayed data stream generated when the target application is running. For example, if the target application is a video application, the second electronic device can only process the data corresponding to the video application at a data processing layer of the second electronic device. For example, in the data processing layer, the second electronic device can interact with a video service platform corresponding to the video application to obtain a video data stream that needs to be output by the video application, instead of displaying the video data stream on the physical display of the second electronic device. Correspondingly, the second electronic device can display a display interface corresponding to a chat application. For this application scenario, to facilitate the second electronic device to obtain the screen-recording data in real-time, the processor of the second electronic device can generate a virtual display of the second electronic device. the video data stream corresponding to the video application can be displayed on the virtual display in real-time. Then, the data stream displayed by the virtual display in real-time can be used as the screen-recording data. Furthermore, the call request sent by the first electronic device through the transmission channel can include related information of the target application, e.g., the name of the target application, and can further include configuration information of the corresponding data transmission interface and configuration information of a target area of the first electronic device for displaying the display data. Then, the second electronic device can create the virtual display according to the configuration information of the target area to cause the screen-recording data generated by the second electronic device to be displayed accurately in the target area of the first electronic device after being transmitted to the first electronic device based on the transmission channel.

In embodiments of the present disclosure, the target identifier corresponding to the target application belonging to the second electronic device can be displayed on the first electronic device. After obtaining the trigger instruction for the target identifier, the call request can be sent based on the transmission channel between the first electronic device and the second electronic device to cause the second electronic device to respond to the call request to run the target application and generate the screen-recording data. Through the transmission channel, the first electronic device can obtain the display data corresponding to the screen-recording data and display the screen-recording data in the target area. Thus, the cumbersome operation steps of establishing the connection between the electronic devices first and then activating the corresponding specific cross-device display application after selecting the target application may not be needed. The cumbersome steps of displaying or operating the data across devices can be simplified to enhance the user experience.

The processing method of embodiments of the present disclosure is described in detail below. To facilitate the user triggering the target identifier representing the target application belonging to the second electronic device, a plurality of identifiers including the target identifier may need to be displayed in an area corresponding to the first electronic device in advance.

In some embodiments, before obtaining the trigger instruction for the target identifier, the method further includes obtaining a candidate identifier based on the transmission channel if the transmission channel between the first electronic device and the second electronic device is established and using the candidate identifier as an object of a target service in the operating system. The target service can be used to represent the identifier of the application. The candidate identifier can include the target identifier.

A plurality of second electronic devices can be provided. When the first electronic device is connected to each of the plurality of second electronic devices, identifiers of applications of each of the plurality of second electronic devices can be obtained. An identifier table corresponding to the identifiers can be generated and stored at the first electronic device locally. When the first electronic device is connected to a corresponding second electronic device again, the identifier table can be directly obtained to use the identifiers in the identifier table as the candidate identifiers. There is no need to obtain the identifiers of the second electronic device again after the first electronic device is connected to the second electronic device. The processing resource for obtaining the identifiers can be saved. When the first electronic device is disconnected from the second electronic device, the candidate identifier corresponding to the second electronic device may not be displayed on the first electronic device again. Correspondingly, the candidate identifiers in the identifier table can be always displayed in the representation area of the target service corresponding to the first electronic device. In some embodiments, when the transmission channel between the first electronic device and the second electronic device is established for the first time, in the subsequent application process, after the user triggers the target identifier, whether the second electronic device corresponding to the target application of the target identifier still have the transmission channel to the first electronic device may need to be detected. If the second electronic device does not have the transmission channel, the second electronic device may need to establish the transmission channel again when transmitting the call request to ensure the subsequent execution process is implemented smoothly.

In some other embodiments, once the first electronic device is successfully connected to the second electronic device, whether the second electronic device is connected to the first electronic device before may not be detected, and the identifiers corresponding to the applications of the second electronic device can be obtained. The identifiers can be determined as the candidate identifiers, which can be used as objects of the target service in the operating system. Thus, the candidate identifiers can be displayed on the first electronic device through the target service. When the first electronic device is disconnected from the second electronic device, the candidate identifiers of the second electronic device can be deleted from the target service of the first electronic device.

The candidate identifiers can be used as the objects of the target service of the operating system of the first electronic device. The target service can be used to represent the identifiers of the applications. That is, the target service can represent the candidate identifiers. The service can be considered as a unit in a control process of performing the user request. The target service can be the service of representing the candidate identifiers. The target service can be a thread, a progress, or an application. For example, the first electronic device can be a computer having a Windows operating system. The target service can be a service representing “a start menu.” Correspondingly, the candidate identifiers can be displayed in the start menu. The target service can also be a desktop management program. The candidate identifier can be displayed on the desktop of the first electronic device through the desktop management program. The target service can be created by a folder. The candidate identifiers can be displayed in the folder created through the folder. In some embodiments, to distinguish different second electronic devices, the folder can be named by the name of the device identifier of the corresponding second electronic device. In embodiments of the present disclosure, the target service can be accessed and operated through the operating system of the first electronic device without installing an additional application for access. In some embodiments, after the first electronic device obtains the identifiers of the second electronic device, the identifiers can be loaded to the target service as the objects of the target service. Then, the candidate identifiers can be displayed in the user interface corresponding to the target service through the target service. If the target service is the start menu progress, the candidate identifiers can be displayed in the start menu. When the user clicks the target identifier in the start menu, the trigger instruction for the target identifier can be obtained.

In some embodiments, if the transmission channel between the first electronic device and the second electronic device is established, the candidate identifiers can be obtained based on the transmission channel. The candidate identifiers can be used as the objects of the target service in the operating system. The target service can be used to display the identifiers of the applications. The trigger instruction for the target identifier of the candidate identifiers can be obtained. The target identifier can belong to the first electronic device. If the target identifier and the target application corresponding to the target identifier belong to the second electronic device, the call request can be sent to the second electronic device through the transmission channel with the second electronic device. The display data can be obtained through the transmission channel. The display data can be the screen-recording data of the second electronic device for the running target application. The display data can be displayed in the target area.

In some embodiments, the first electronic device has already established the transmission channel with the second electronic device. The first electronic device and the second electronic device perform instruction data and screen-recording data transmission based on the transmission channel. After the user triggers the target identifier, a corresponding trigger instruction can be generated. The trigger instruction can indicate that the user needs to run the target application corresponding to the target identifier. Since the first electronic device does not have the target application, the call request corresponding to the target application may need to be sent through the transmission channel to cause the second electronic device to start the target application, obtain the screen-recording data when running the target application, and return the screen-recording data to the first electronic device for display. The user can directly send the target identifier of the target application of the second electronic device to the first electronic device. That is, the display data of the target application can be obtained without repeatedly performing operations on the first electronic device and the second electronic device to enhance the user experience.

In some other embodiments of the present disclosure, before obtaining the trigger instruction for the target identifier, the method can further include determining the candidate identifier corresponding to the second electronic device if the transmission channel between the first electronic device and the second electronic device is established and using the candidate identifier as the object of the target service of the operating system. The target service can be used to display the identifier of the target application.

The transmission channel can be established between the first electronic device and the second electronic device. That is, the first electronic device can perform data transmission with the second electronic device. For example, the transmission channel can be a wireless network transmission channel within the LAN. When the second electronic device is within the distance range of the first electronic device, the transmission channel between the first electronic device and the second electronic device can be determined to be established. The first electronic device may pre-store an identifier list of all electronic devices that have been connected to the first electronic device. When the transmission channel is identified to be established with the second electronic device, the candidate identifier corresponding to the second electronic device can be determined from in list. The candidate identifiers can be displayed in the display area corresponding to the target service through the target service. Thus, after the user triggers the target identifier in the candidate identifiers, since the transmission channel between the first electronic device and the second electronic device has already been established, the call request can be sent based on the transmission channel, and the screen-recording data of the second electronic device can be received as the display data for display. In embodiments of the present disclosure, the candidate identifiers corresponding to the second electronic device can be determined after the transmission channel between the first electronic device and the second electronic device is established. Thus, the user can trigger the target identifier in the candidate identifiers to implement the subsequent operations without detecting the transmission channel after triggering the target identifier.

In some other embodiments of the present disclosure, sending the call request through the transmission channel with the second electronic device if the target identifier represents that the target application corresponding to the target identifier belongs to the second electronic device can further include obtaining a connection status if the target identifier and the target application corresponding to the target identifier belong to the second electronic device, establishing the transmission channel with the second electronic device if the connection status indicating that the transmission channel between the first electronic device and the second electronic device is not established, and sending the call request based on the transmission channel with the second electronic device.

The trigger instruction for the target identifier can be obtained, and the target identifier can belong to the first electronic device. That is, the target identifier can be one identifier of the identifiers displayed by the first electronic device. If the target application corresponding to the target identifier belongs to the second electronic device, the connection status of the first electronic device and the second electronic device can be obtained. Whether the first electronic device establishes the transmission channel with the second electronic device can be determined based on the connection status. If the transmission channel is established, the call request for the target application can be sent based on the transmission channel. Correspondingly, the second electronic device can also send the display data based on the transmission channel. If the connection status indicates that the transmission channel between the first electronic device and the second electronic device is not established, the transmission channel between the first electronic device and the second electronic device may need to be established, and the call request can be then sent based on the transmission channel.

Based on the connection method of the first electronic device and the second electronic device satisfying the current application, the connection status between the first electronic device and the second electronic device can be obtained.

The connection status between the first electronic device and the second electronic device can be determined based on the connection method that meets the current application requirements of the first electronic device and the second electronic device. For example, if the display information that the first electronic device needs to display is the screen projection content of the second electronic device, the first electronic device and the second electronic device may need to establish the transmission channel based on the same wireless LAN. Thus, the connection status can include network feature information of the first electronic device and the second electronic device. That is, whether the first electronic device and the second electronic device activate the wireless network connection may need to be detected, and whether the wireless network accessed by the first electronic device and the wireless network accessed by the second electronic device are the same wireless LAN may need to be detected. If the above conditions are not met, the connection status can indicate that the first electronic device and the second electronic device do not establish the transmission channel. The first electronic device and the second electronic device can be controlled to access the same wireless LAN to establish the transmission channel between the first electronic device and the second electronic device. A patterned code corresponding to the second electronic device can be generated on the first electronic device. The second electronic device can be controlled to scan the patterned code of the first electronic device to establish a communication connection processing progress and exchange and verify information such as pairing passcode. After the verification is successful, the transmission channel between the first electronic device and the second electronic device can be established. Then, the first electronic device can send the call request to the second electronic device based on the transmission channel. The second electronic device can transmit the screen-recording data corresponding to the target application and displayed on the first electronic device based on the transmission channel. Thus, the first electronic device can display the screen-recording data in the corresponding target area as the display data.

To ensure that the first electronic device successfully receives and displays the corresponding display data, obtaining the display data through the transmission channel can include establishing the service, the service being used to monitor the transmission data of the interface, and establishing the interface, the interface being configured for the second electronic device to provide the screen-recording data based on the interface.

To ensure that the first electronic device can accurately receive the data transmitted by the second electronic device in real-time to continuously represent the screen-recording data transmitted by the second electronic device and avoid pause or interruption, a service can be pre-established at the first electronic device to monitor the interface of the second electronic device for returning the data to ensure to obtain the data stream in real-time. Correspondingly, the service can be used to parse the data transmitted by the second electronic device. For the safety and efficiency of the data transmission, the transmitted data can be encrypted and encoded. After the first electronic device receives the screen-recording data, the first electronic device can perform decryption and decoding on the screen-recording data to display the screen-recording data on the corresponding target area based on the established service. For example, the screen-recording data can be displayed on the display of the first electronic device in full screen or in a display window. Correspondingly, the first electronic device can determine or establish an interface. The interface can be configured for the second electronic device to transmit the screen-recording data, which avoids occupying the interfaces of other devices for transmitting the data to the first electronic device. Thus, the safety and efficiency of the data transmission can be ensured.

In embodiments of the present disclosure, the identifiers of the applications of the second electronic device that can establish the transmission channel with the first electronic device can be stored in the first electronic device and displayed in advance. Thus, the user can trigger the identifier on the first electronic device corresponding to the target application of the second electronic device. The target application can be activated, and the display data when the target application is running can be obtained, which simplifies the cumbersome steps of cross-device data display or operation and enhances the user experience.

The processing method of embodiments of the present disclosure is described below by taking a screen projection application as an example. For example, the first electronic device can be a personal computer (PC), and the second electronic device can be a cell phone. The video content of the video application of the cell phone may need to be projected and displayed on the PC. In an existing operation, the PC and the cell phone may need to be paired and connected first. Then, the video application that needs to be screen-projected can be selected on the cell phone. The video application can be activated, and the screen projection operation can be selected. Then, the video content of the video application of the cell phone can be displayed on the computer.

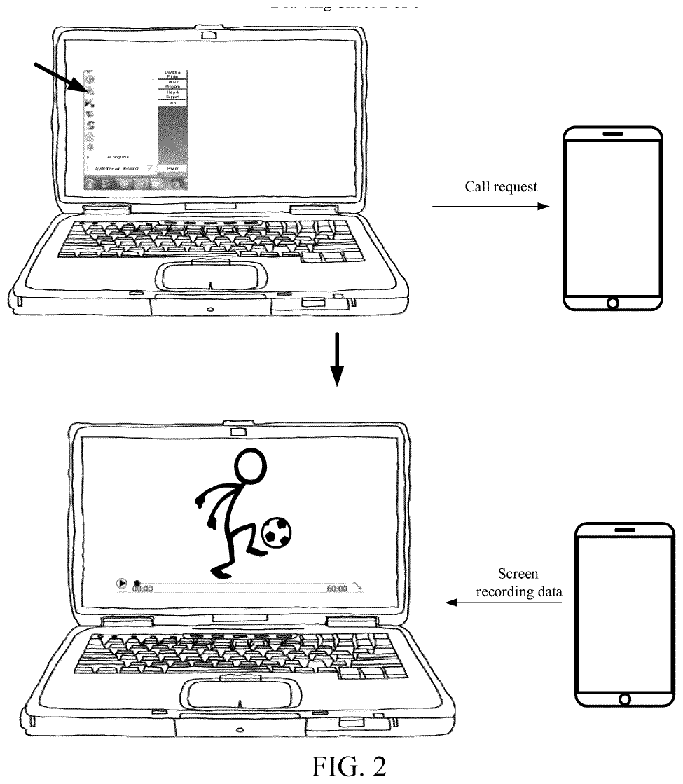

FIG. 2 illustrates a schematic diagram of an application scenario according to some embodiments of the present disclosure. In embodiments of the present disclosure, the video application of the cell phone can be directly added to the start menu of the PC. When the user clicks the video application in the start menu, the backend of the PC can send the call request of calling the video application to the cell phone. The cell phone can perform screen recording operation on the to-be-displayed data of the video application in real-time after the video application is activated, and the screen-recording data can be transmitted to the PC for display. Thus, in embodiments of the present disclosure, on the user side, the user may only need to trigger the video application in the start menu, and no other cumbersome triggering operations are needed, which enhances the user experience.

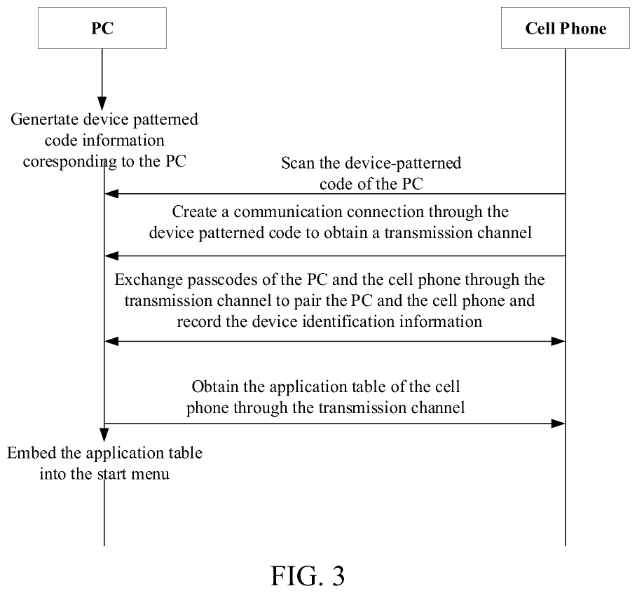

FIG. 3 illustrates a schematic flowchart of adding an application identification of a cell phone to a PC terminal according to some embodiments of the present disclosure.

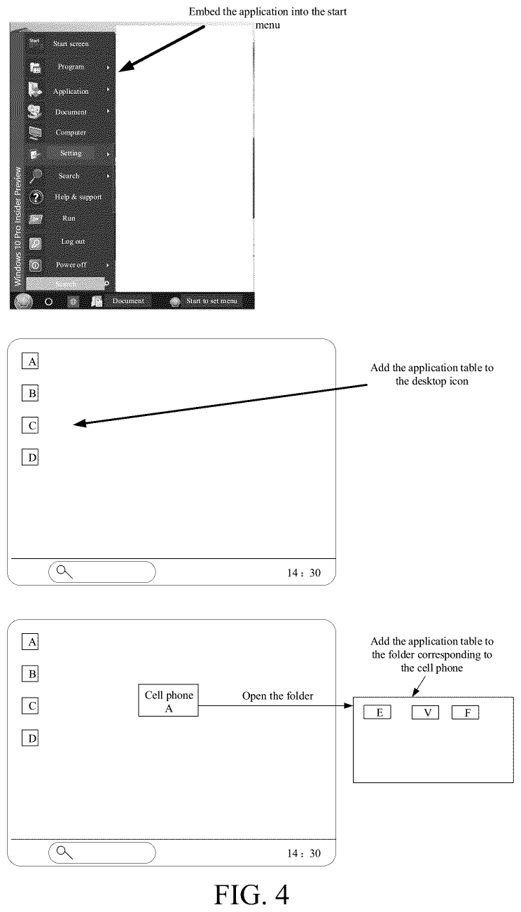

The PC can generate device-patterned code information corresponding to the PC through the screen projection application or pairing connection application. The device-patterned code can be a QR code, an image code, or a barcode. The cell phone can scan the device patterned code of the PC through the corresponding screen projection application or other applications that support the pairing connection. A communication connection protocol (such as WebSocket) can be established through the device-patterned code information. The device-patterned code information can include device network address information (IP), device port information, or register (fp) information. Then, the passcodes of the PC and the cell phone can be exchanged through the communication connection protocol to pair the PC and the cell phone. Thus, the PC and the cell phone can record the device identification information of each other. After the PC is paired with the cell phone, the transmission channel between the PC and the cell phone is established. The application list of the cell phone can be obtained through the transmission channel. The application list of the cell phone can be displayed in the start menu of the PC, a specific area of the desktop, or a folder named with the cell phone device name. FIG. 4 illustrates a schematic diagram of embedding an application list of a cell phone in a corresponding identification display area of a PC according to some embodiments of the present disclosure. In FIG. 4, schematic diagrams of embedding the application list into the start menu, the desktop display area, and the cell phone folder are shown from top to bottom.

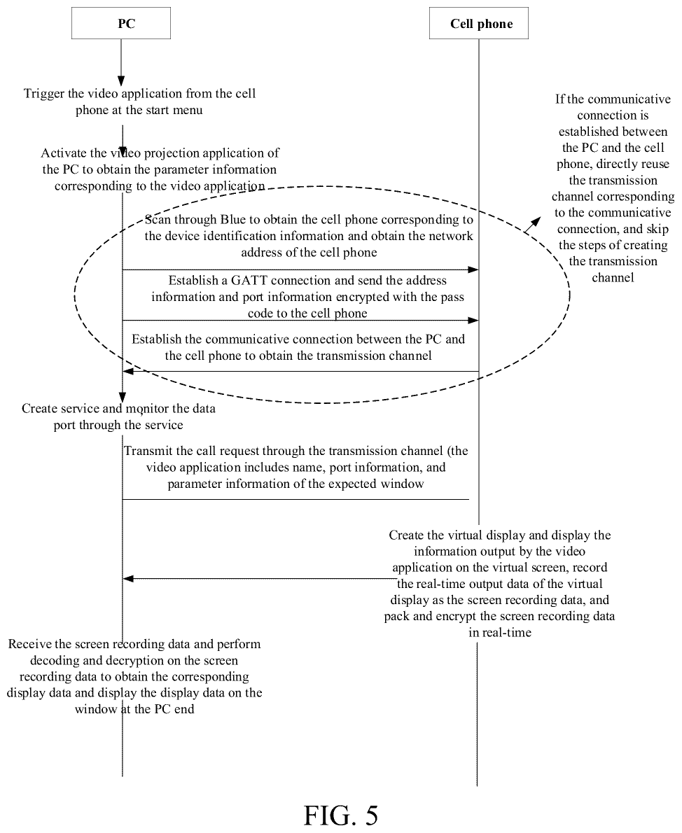

The process of activating the cell phone application from the start menu is described by embedding the application list of the cell phone into the start menu of the PC as an example. FIG. 5 illustrates a schematic flowchart of activating the application of the cell phone from the PC according to some embodiments of the present disclosure.

First, the user can select an application of the cell phone from the start menu of the PC, e.g., the video application. Then, the video projection application of the PC can be activated to obtain parameter information corresponding to the video application. The parameter information can include device identification information of the cell phone corresponding to the video application and name information of the video application. Through the corresponding broadcasting scanning with Bluetooth low energy (Ble), the cell phone corresponding to the device identification information can be obtained. The network address of the cell phone can be obtained, and the Bluetooth GATT connection can be established. Genericattributes (GATT) is a communication protocol for Blue devices. Then, the address information and interface information encrypted with the pairing passcode. The communication connection between the PC and the cell phone can be established using the information to obtain the transmission channel. If the PC and the cell phone have already established the communication connection, the transmission channel corresponding to the communication connection can be directly reused, and the above establishment steps can be skipped.

The service and the port can be established at the cell phone end. The service can be a user datagram protocol (UDP) service. The port can be a UDP port. The data transmission of the port can be monitored through the service. The port can be configured for the cell phone to transmit the corresponding data to the PC. Then, the PC can send the call request corresponding to the video application to the cell phone through the transmission channel. The call request can include the name of the application packet of the video application, the port information, parameter information of an expected display window, e.g., width, height, and resolution of the display window.

After receiving the call request, the cell phone can activate the corresponding screen-projection application, create the virtual display screen, activate the video application, and display the output information of the video application on the virtual display. Simultaneously, the cell phone can record the real-time output data of the virtual display as the screen-recording data. Then, the cell phone can encrypt and pack the screen-recording data based on the secure real-time transport protocol (SRTP) and send the screen-recording data to the PC through the port. When the created service detects the screen-recording data transmitted from the port, the screen-recording data can be received. Then, the decoding and decryption can be performed on the screen-recording data to obtain the corresponding display data. The display data can be displayed on the window at the PC end.

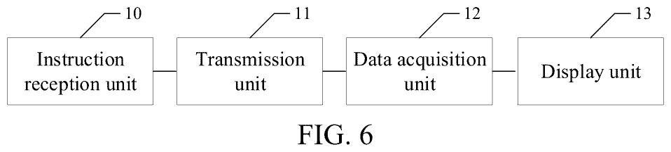

Embodiments of the present disclosure can further provide a processing system. The processing system can be integrated into the operating system of the electronic device and installed into the electronic device as an independent application. When the electronic device is running the processing system, the related steps of the above processing method can be implemented. As shown in FIG. 6, the processing system includes an instruction reception unit 10, a transmission unit 11, a data acquisition unit 12, and a display unit 13.

The instruction reception unit 10 can be configured to obtain a trigger instruction for the target identifier. The target identification can belong to the first electronic device.

The transmission unit 11 can be configured to send the call request through the transmission channel with the second electronic device if the target identifier indicates that the target application corresponding to the target identifier belongs to the second electronic device.

Data acquisition unit 12 can be configured to obtain the display data through the transmission channel. The display data can be the screen-recording data of the second electronic device for the running target application.

Display unit 13 can be configured to display the display data in the target area.

In some embodiments, the system can further include a first identifier acquisition unit. The first identifier acquisition unit can be configured to obtain the candidate identifier based on the transmission channel if the transmission channel between the first electronic device and the second electronic device is established. The candidate identifier can include the target identifier. The candidate identifier can be used as the object of the target service in the operating system. The target service can be used to display the identifier of the application.

In some other embodiments, the system can further include a second identifier acquisition unit. The second identifier acquisition unit can be configured to determine the candidate identifier corresponding to the second electronic device if the transmission channel between the first electronic device and the second electronic device is established, the candidate identifier including the target identifier, and using the candidate identifier as the object of the target service of the operating system. The target service can be used to display the identifier of the application.

In some embodiments, the transmission unit can be configured to obtain the connection status if the target identifier indicates that the target application corresponding to the target identifier belongs to the second electronic device, establish the transmission channel with the second electronic device if the connection status indicates that the transmission channel between the first electronic device and the second electronic device is not established, and send the call request based on the transmission channel of the second electronic device.

In some embodiments, the system can further include an establishment unit.

The establishment unit can be configured to create the service, the service being used to monitor the transmission data of the port, and create the port, the port being configured for the second electronic device to provide the screen-recording data based on the port.

In some embodiments, for specific embodiments of the units and sub-units, reference can be made to the related content above, which is not repeated.

Some other embodiments of the present disclosure further provide the first electronic device, including a display and a processor.

The processor can be configured to respond to the trigger instruction for the target identifier to generate the call request and send the call request through the transmission channel of the second electronic device if the target application corresponding to the target identifier of the first electronic device belongs to the second electronic device, and obtain the display data through the transmission channel. The display data can be the screen-recording data of the second electronic device of the running target application.

The display can be configured to display the display data.

In some embodiments, the processor can be further configured to obtain the candidate identifier based on the transmission channel if the transmission channel between the first electronic device and the second electronic is established, the candidate identifier including the target identifier, and using the candidate identifier as the object of the target service of the operating system. The target service is used to display the identifier of the application.

In some embodiments, the processor can be further configured to determine the candidate identifier corresponding to the second electronic device if the transmission channel between the first electronic device and the second electronic device is established, the candidate identifier including the target identifier, and using the candidate identifier as the object of the target service of the operating system. The target service can be used to display the identifier of the application.

In some embodiments, the processor can be further configured to obtain the connection status if the target identifier indicates that the target application corresponding to the target identifier belongs to the second electronic device, establish the transmission channel with the second electronic device if the connection status indicates that the transmission channel between the first electronic device and the second electronic device is not established, and send the call request based on the transmission channel of the second electronic device.

In some embodiments, the processor can be further configured to establish the service, the service being used to monitor the transmission data of the port, and establish the port, the port being configured for the second electronic device to provide the screen-recording data based on the port.

In some other embodiments, a computer-readable storage medium can be provided. The computer-readable storage medium can store a computer program that, when the computer program is executed by the processor, causes the processor to implement the steps of the processing method above.

For specific embodiments of the processor, reference can be made to the related content above, which are not repeated here.

Embodiments of the present disclosure are described in a progressive manner. Each embodiment focuses on the differences from other embodiments. The same or similar parts between embodiments can be referred to each other. For the apparatus of embodiments of the present disclosure, since apparatus corresponds to the method of embodiments of the present disclosure, the apparatus can be simply described. For the relevant parts, reference can be made to the description of the method.

Those skilled in the art can further realize that units and algorithm steps described in embodiments of the present disclosure can be implemented by electronic hardware, computer software, or a combination thereof. To describe the interchangeability between the hardware and the software, the composition and steps of each example have been described in a general manner according to functionality. Whether the functions are performed by hardware or software depends on the specific application and design constraints of the technical solution. Those skilled in the art can use different methods to implement the described functions for each specific application, which is within the scope of the present disclosure.

The methods or algorithmic steps of embodiments of the present disclosure can be implemented directly by the hardware, the software module performed by the processor, or a combination thereof. The software module can be stored in random access memory (RAM), memory, read-only memory (ROM), electrically programmable ROM, electrically erasable programmable ROM, registers, hard disks, removable disks, CD-ROMs, or any other form of storage medium known in the art.

The above description of embodiments of the present disclosure can cause those skilled in the art to realize or use the present disclosure. Various modifications to embodiments of the present disclosure can be obvious for those skilled in the art. The general principle defined in the present disclosure can be implemented in other embodiments without departing from the spirit or scope of the present disclosure. Thus, the present disclosure is not limited to embodiments of the present disclosure but can conform to the widest scope consistent with the principle and novel features of the present disclosure.

What is claimed is:

1. A processing method comprising:
obtaining a trigger instruction for a target identifier, the target identifier belonging to a first electronic device;
in response to the target identifier indicating that a target application corresponding to the target identifier belongs to a second electronic device, sending a call request through a transmission channel with the second electronic device;
obtaining display data through the transmission channel, the display data being screen-recording data of the second electronic device for the running target application; and
displaying the display data in a target area.

2. The method according to claim 1, further comprising, before obtaining the trigger instruction for the target identifier:
in response to establishing the transmission channel between the first electronic device and the second electronic device, obtaining a candidate identifier based on the transmission channel, the candidate identifier including the target identifier; and
using the candidate identifier as an object of a target service in an operating system, the target service being used to display an identifier of an application.

3. The method according to claim 1, further comprising, before obtaining the trigger instruction for the target identifier:
in response to establishing the transmission channel between the first electronic device and the second electronic device, determining a candidate identifier corresponding to the second electronic device, the candidate identifier including the target identifier; and
using the candidate identifier as an object of the target service in the operating system, the target service being used to display an identifier of an application.

4. The method according to claim 1, wherein sending the call request through the transmission channel with the second electronic device in response to the target identifier indicating that the target application corresponding to the target identifier belongs to the second electronic device includes:
obtaining a connection status in response to the target identifier indicates that the target application corresponding to the target identifier belongs to the second electronic device;
establishing the transmission channel with the second electronic device in response to the connection status indicates that the transmission channel between the first electronic device and the second electronic device is not established; and
sending the call request based on the transmission channel with the second electronic device.

5. The method according to claim 1, wherein obtaining the display data through the transmission channel includes:
creating a service, the service being used to monitor transmission data of the port; and
creating a port, the port being configured for the second electronic device to provide the screen-recording data based on the port.

6. An operating system comprising:
an instruction reception unit configured to obtain a trigger instruction for a target identifier, the target identifier belonging to a first electronic device;
a transmission unit configured to, in response to the target identifier indicating that a target application corresponding to the target identifier belongs to a second electronic device, send a call request through a transmission channel with the second electronic device;
a data acquisition unit configured to obtain display data through the transmission channel, the display data being screen-recording data of the second electronic device for the running target application; and
a display unit configured to display the display data in a target area.

7. The system according to claim 6, further comprising:
a first identification acquisition unit configured to, in response to establishing the transmission channel between the first electronic device and the second electronic device, obtain a candidate identifier based on the transmission channel, the candidate identifier including the target identifier, and use the candidate identifier as an object of a target service in the operating system, the target service being used to display an identifier of an application.

8. The system according to claim 6, further comprising:
a second identification acquisition unit configured to, in response to establishing the transmission channel between the first electronic device and the second electronic device, determine a candidate identifier corresponding to the second electronic device, the candidate identifier including the target identifier, and use the candidate identifier as an object of the target service in the operating system, the target service being used to display an identifier of an application.

9. The system according to claim 6, wherein the transmission unit is further configured to:
obtain a connection status in response to the target identifier indicates that the target application corresponding to the target identifier belongs to the second electronic device;
establish the transmission channel with the second electronic device in response to the connection status indicates that the transmission channel between the first electronic device and the second electronic device is not established; and
send the call request based on the transmission channel with the second electronic device.

10. The system according to claim 6, further comprising a creation unit configured to:
create a service, the service being used to monitor transmission data of the port; and
create a port, the port being configured for the second electronic device to provide the screen-recording data based on the port.

11. A first electronic device comprising:
one or more processors configured to:
in response to a target application corresponding to a target identifier of the first electronic device belonging to a second electronic device, generate a call request in response to a trigger instruction for the target identifier;
send the call request through a transmission channel with the second electronic device; and
obtain display data through the transmission channel, the display data being screen-recording data of the second electronic device for the running target application; and
a display configured to display the display data.

12. The device according to claim 11, wherein the one or more processors are further configured to:
in response to establishing the transmission channel between the first electronic device and the second electronic device, obtain a candidate identifier based on the transmission channel, the candidate identifier including the target identifier; and
use the candidate identifier as an object of a target service in an operating system, the target service being used to display an identifier of an application.

13. The device according to claim 11, wherein the one or more processors are further configured to:
in response to establishing the transmission channel between the first electronic device and the second electronic device, determine a candidate identifier corresponding to the second electronic device, the candidate identifier including the target identifier; and
use the candidate identifier as an object of the target service in the operating system, the target service being used to display an identifier of an application.

14. The device according to claim 11, wherein the one or more processors are further configured to:
obtain a connection status in response to the target identifier indicates that the target application corresponding to the target identifier belongs to the second electronic device;
establish the transmission channel with the second electronic device in response to the connection status indicates that the transmission channel between the first electronic device and the second electronic device is not established; and
send the call request based on the transmission channel with the second electronic device.

15. The device according to claim 11, wherein the one or more processors are further configured to:
create a service, the service being used to monitor transmission data of the port; and create a port, the port being configured for the second electronic device to provide the screen-recording data based on the port.
